(19) United States
(12) Patent Application Publication
(10) Pub. No.: US 2022/0138235 A1
(43) Pub. Date: May 5, 2022

(54) CONFIDENCE SCORING OF GEOCODER RESULTS IN COMPUTER-BASED NAVIGATION

(71) Applicants: SHANTANU BHATTACHARYYA, New Delhi (IN); GEET GARG, New Delhi (IN); VITTAL SIRIGIRI, Bengaluru (IN); DARSHAN KATHIRIYA, Surat (IN)

(72) Inventors: SHANTANU BHATTACHARYYA, New Delhi (IN); GEET GARG, New Delhi (IN); VITTAL SIRIGIRI, Bengaluru (IN); DARSHAN KATHIRIYA, Surat (IN)

(21) Appl. No.: 17/090,865

(22) Filed: Nov. 5, 2020

(51) Int. Cl. G06F 16/29; G01C 21/00

(52) U.S. Cl. CPC G06F 16/29; G01C 21/3874; G01C 21/3811

(57) ABSTRACT

In one aspect, a method comprises identifying a set of main components of an address that have a highest importance for a specified geography are identified. The method comprises providing a geocoding database comprising a dataset of geocoded addresses of a geocoder. The method comprises receiving a set of responses from the geocoding database, wherein each response comprises a geocoded addresses of the geocoding database. The method comprises breaking each response into a set of components. The method comprises, based on the set of components, matching the address and each response in the set of components; based on the match, calculating a string similarity score and a component match score of each response between the address and each response. The method comprises sorting the responses based on the string similarity score of each response and the component match score of each response. The method comprises selecting a first response of the set of responses after sorting as the best response. The method comprises calculating a confidence score of the first response, wherein the confidence score is calculated using a formula which depends on the string similarity score and the component match score of the first response.

### BACKGROUND

Geocoding is the technique of attributing a GPS coordinate to a human readable, typically text based, address. The geocoding process converts a given address into a coordinate, a latitude, and a longitude. When a geocoder service returns a response to a customer's computing system, the geocoder can return a ‘confidence’ or a ‘relevance’ score to indicate the quality of the returned response as compared to the original request made by the customer.

A geocoder can find multiple responses to a request made by the customer. The geocoder can determine a best response amongst the multiple responses. Furthermore, the geocoder has to assign a single score to the returned response to indicate the quality of the output. Accordingly, improvements to geocoder responses that provide a single score to help the customer understand the quality of the response are desired.

### BRIEF SUMMARY

In one aspect, a method comprises identifying a set of main components of an address that have a highest importance for a specified geography are identified. The method comprises providing a geocoding database comprising a dataset of geocoded addresses of a geocoder. The method comprises receiving a set of responses from the geocoding database, wherein each response comprises a geocoded addresses of the geocoding database. The method comprises breaking each response into a set of components. The method comprises, based on the set of components, matching the address and each response in the set of components; based on the match, calculating a string similarity score and a component match score of each response between the address and each response. The method comprises sorting the responses based on the string similarity score of each response and the component match score of each response. The method comprises selecting a first response of the set of responses after sorting as the best response. The method comprises calculating a confidence score of the first response, wherein the confidence score is calculated using a formula which depends on the string similarity score and the component match score of the first response.

### BRIEF DESCRIPTION OF THE DRAWINGS

FIG. 1 illustrates an example process for determining POIs and/or specified regions within a city, according to some embodiments.

FIG. 2 illustrates an example geocoder process, according to some embodiments.

FIG. 3 illustrates an example process for response analysis, according to some embodiments.

FIG. 4 illustrates an example response sorting process, according to some embodiments.

FIG. 5 illustrates an example routing system for implementing automated routing optimization, according to some embodiments.

FIG. 6 depicts an exemplary computing system that can be configured to perform any one of the processes provided herein.

FIG. 7 illustrates an example use case, according to some embodiments.

FIG. 8 illustrates an example set of other returned confidence scores that are not selected, according to some embodiments.

The Figures described above are a representative set and are not an exhaustive with respect to embodying the invention.

### DESCRIPTION

Disclosed are a system, method, and article for confidence scoring of geocoder results in computer-based navigation. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment, according to some embodiments. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Application programming interface (API) can specify how software components of various systems interact with each other.

Cloud computing can involve deploying groups of remote servers and/or software networks that allow centralized data storage and online access to computer services or resources. These groups of remote serves and/or software networks can be a collection of remote computing services.

Global Positioning System (GPS) is a satellite-based radio navigation system owned by the United States government and operated by the United States Space Force.

Latitude is a geographic coordinate that specifies the north-south position of a point on the Earth's surface. Latitude is an angle which ranges from 0° at the Equator to 90° (North or South) at the poles.

Longitude is a geographic coordinate that specifies the east-west position of a point on the Earth's surface. Longitude is an angular measurement (e.g. expressed in degrees). A longitude pair (latlng) can be a pair of latitude and longitude coordinates.

n-gram is a contiguous sequence of n items from a given sample of text or speech. The items can be phonemes, syllables, letters, words, or base pairs according to the application.

Point of interest (POI) can be a specific point location that someone may find useful or interesting.

Trigrams are a special case of the n-gram, where n is there (3).

Example Methods

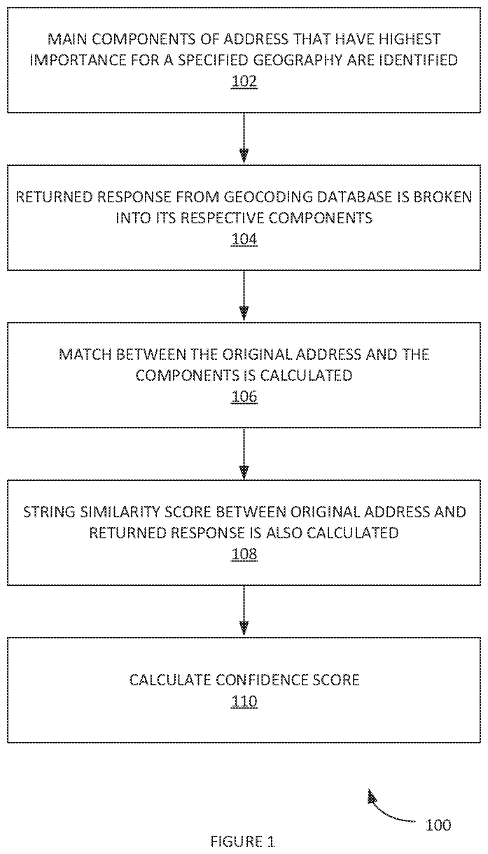

FIG. 1 illustrates an example process 100 for determining POIs and/or specified regions within a city (e.g. a locality), according to some embodiments. In step 102, the main components of the address that have the highest importance for a specified geography are identified. It is noted that an address has multiple components. Example component can include, inter alia: country, state, city, locality, etc.

In one example, process 100 can use four component types. These can include point of interest. The point of interest can contain sub-components such as, inter alia: premise, establishment, building etc. A street component can include sub-components such as, inter alia: route, intersection etc. A locality component can include sub-components such as, inter alia: neighborhood, sub-locality, administrative levels, etc. The postal code can include sub-components such as, inter alia: postal code, etc.

In step 104, a returned response from the geocoding database (e.g. dataset of geocoded addresses 512) is broken into its respective components. In step 106, based on the identified important components, a match between the original address and the components is calculated. In step 108, a string similarity score between the original address and returned response is also calculated. The responses are then sorted based on the string similarity and component match scores and the first response after sorting is chosen as the best response. In step 110, once the best response is chosen, a confidence score is calculated using a formula which depends on the string similarity and component match scores.

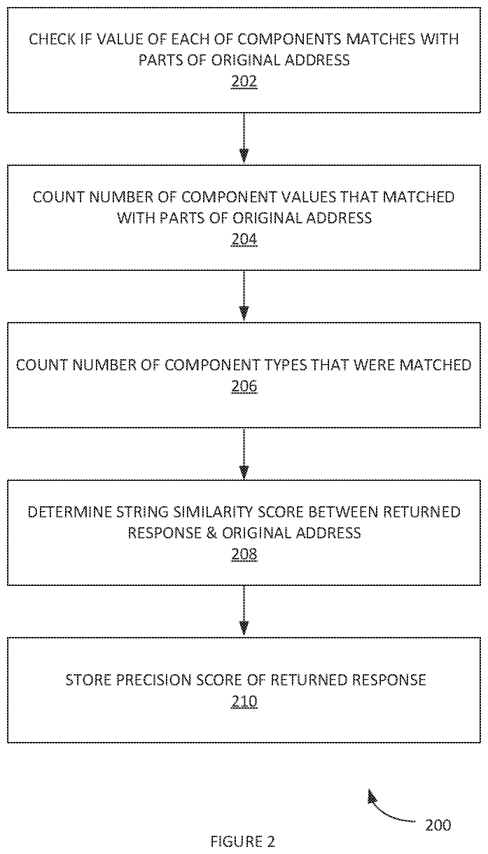

FIG. 2 illustrates an example geocoder process 200, according to some embodiments. Given an address to be geocoded, a geocoder (e.g. geocoder 516 discussed infra) uses process 200 to return multiple responses. Each response is broken into multiple components. For each response, process 200 implements the following steps. In step 202, process 200 checks if the value of each of the components matches with parts of the original address. In step 204, process 200 counts the number of component values that matched with parts of the original address (e.g. components matched). In step 206, process 200 counts the number of component types that were matched (e.g. component types matched). In step 208, process 200 determines a string similarity score between the returned response and original address (e.g. similarity score). In step 210, process 200 stores the precision score (e.g. based on a component matching, etc.) of the returned response (e.g. precision score).

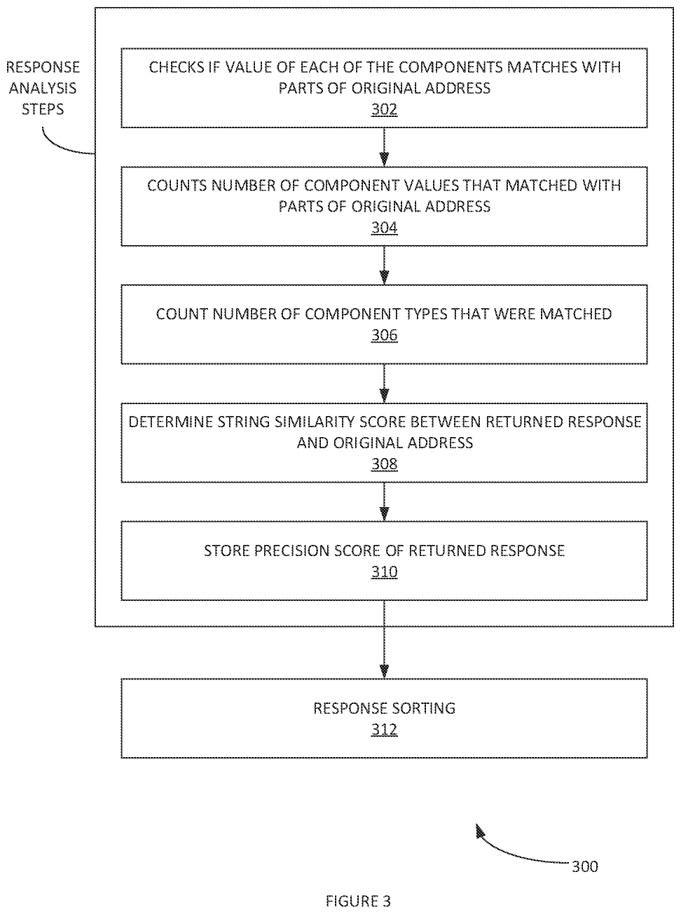

FIG. 3 illustrates an example process 300 for response analysis, according to some embodiments. For each response, process 300 implements the following algorithm. In step 302, process 300 checks if the value of each of the components matches with parts of the original address. In step 304, process 300 counts the number of component values that matched with parts of the original address (e.g. components matched). In step 306, process 300 counts the number of component types that were matched (e.g. component types matched). In step 308, process 300 determines a string similarity score between the returned response and original address (e.g. similarity score). In step 310, process 300 stores the precision score of the returned response (e.g. precision score).

Once these five steps are conducted process 300 sorts the responses. Process 300 can use process 400 for response sorting.

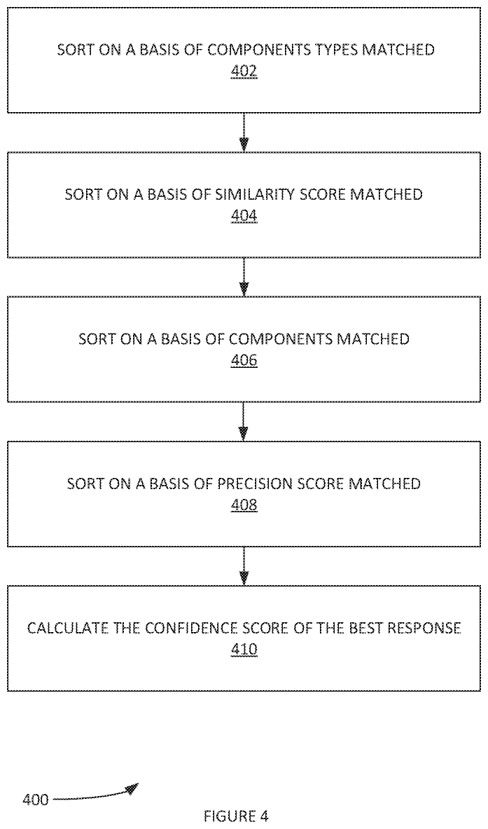

FIG. 4 illustrates an example response sorting process 400, according to some embodiments. In step 402, process 400 sorts on a basis of components types matched (e.g. a higher value is viewed as better). In step 404, process 400 sorts on a basis of similarity score matched (e.g. a higher value is viewed as better). In step 406, process 400 sorts on a basis of components matched (e.g. a higher value is viewed as better). In step 408, process 400 sorts on a basis of precision score matched (e.g. a higher value is viewed as better). Once all the responses are sorted in this fashion, the first response in the list is the best response. In step 408, process 400 calculates the confidence score of the best response.

In one example, the confidence score can be calculated as per the following formula:

Confidence score=similarity score+25*component types matched+5*components matched. This confidence score can be normalized by dividing it by 225. This is multiplied by 100 and rounded down to convert it into an integer.

Example Systems

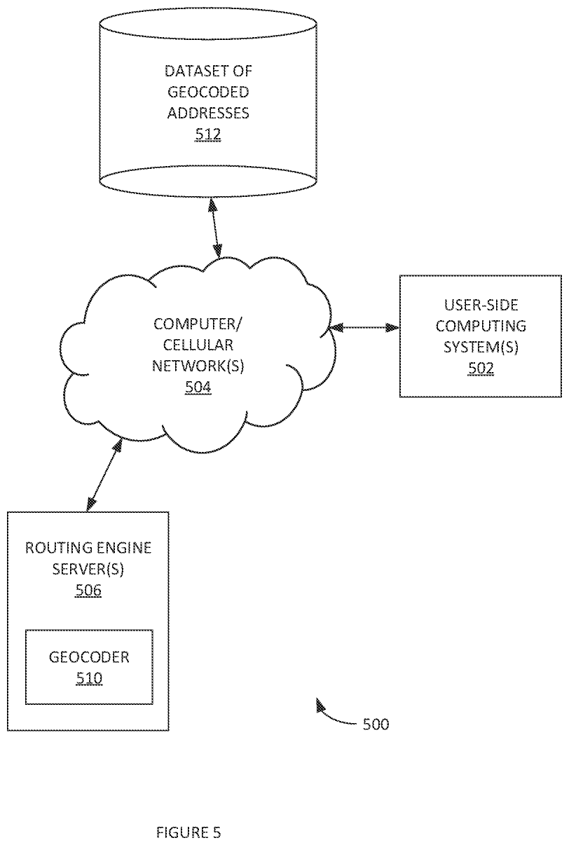

FIG. 5 illustrates an example routing system 500 for implementing automated routing optimization, according to some embodiments.

In one example, a supply chain optimization entity use routing system 500. Routing system 500 can include a Routing engine server(s) 506. Routing engine server(s) 506 can include one or more routing engines. A routing engines can create a delivery plan of those orders distributed into vehicles. Routing engines can use process 100 and 200 to optimize the delivery plan.

Routing system 500 can include user-side computing system(s) 502. User-side computing system(s) 502 can include various geo-location applications, navigation applications and/or mapping applications. Routing information can be communicated to these application. For example, navigation application can use an Internet connection to a GPS navigation system to provide turn-by-turn voice-guided instructions on how to arrive at a given destination. The navigation application can use a connection to Internet data (e.g. 5G, 4G, WiFi, etc.) and use a GPS satellite connection to determine the user-side computing system(s) 502. Local addresses, regions and/or POI can be identified using processes 100 and 200. A user can enter a destination into the navigation application. This address can be processed by processes 100 and 200. The navigation application can plot a path to it. The navigation application can display the user's progress along the route and issues instructions for each turn.

In the incremental delivery plan, the routing engine of routing engine server(s) 506 retains the existing allocated orders in the same vehicles as before and then allocates all the newly added orders into extra space present in existing vehicles or any newly added vehicles provided while running the incremental delivery plan. In this way, the vehicles that have been previously loaded do not have to be unloaded (except in case of canceled tasks). Only new orders are allocated into them. Routing engine server(s) 506 can repeat the process of adding more tasks and run an incremental plan on as as-needed basis.

Since all tasks are not considered in shuffling for optimization, this solution trades off optimality for convenience in operations. If the number of tasks added later is much less than the original set of tasks considered in the first delivery plan, the gap in optimality is usually quite small.

User-side computing system(s) 502 can be mobile device(s), laptops, etc. that include an automated salesbeat optimization application (e.g. a sales-fleet management application). User-side computing system(s) 502 can communicate delivery and/or load allocation information to Routing engine server(s) 506.

Computer/Cellular networks 504 can include the Internet, text messaging networks (e.g. short messaging service (SMS) networks, multimedia messaging service (MMS) networks, proprietary messaging networks, instant messaging service networks, email systems, etc. Computer/Cellular networks 504 can include cellular networks, satellite networks, etc. Computer/Cellular networks 504 can be used to communicate messages and/or other information (e.g. videos, tests, articles, digital images, videos etc.) from the various entities of routing system 500.

Routing engine server(s) 506 can include various other functionalities such as, inter alia: web servers, SMS servers, IM servers, chat bots, database system managers, e-commerce engines, geo-mapping functionalities, web mapping services, etc. Routing engine server(s) 506 can include manage a mobile-device application in both user-side computing device(s) 502.

Routing engine server(s) 506 can manage an API service which clients may communicate with via RESTful HTTP APIs. These APIs enable a client to pass input data like details of batch of orders to be fulfilled, vehicle information and configurations. This API system stores the details and invokes the route optimization engine to come up with a delivery plan. Routing engine server(s) 506 can accept additional orders on the same batch of orders once the delivery plan is generated. The routing engine can build an incremental solution using an existing delivery plan and newer orders added to the existing batch of orders. The API service can accept newer orders on the same batch of tasks. The routing engine can create an incremental plan based on an existing delivery plan and additional orders.

Routing engine server(s) 506 can manage messages about the batch of orders and existing delivery plan. Data can be stored and read from a common database. Messages containing metadata are passed using queues, and the systems fetch the required data from the database by querying using the metadata from the message.

As shown, routing engine server(s) 506 can interact with any client systems (e.g. dispatcher(s) computing device(s) 502, etc.). Clients can automatically or manually load vehicles according to the delivery plan generated by the routing engine mentioned. In this way, routing system 500 can simplify operations as vehicles do not have to be reloaded completely on every optimization run.

Routing engine server(s) 506 can utilize machine learning techniques (e.g. artificial neural networks, etc.). Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning.

Routing engine server(s) 506 can include geocoder 510. Geocoder 510 can use processes 100, 200, and 300. Geocoder may not treat all components equally. Not all components are treated equally. Based on research and understanding the nuances of the addressing system of a country, the most important component types are selected and only those components are used for matching. Geocoder 510 can distinguish between component types and component values themselves. Geocoder 510 can count component type of locality only once. Geocoder 510 can distinguish between the types and values. Geocoder 510 can provide a single integrated confidence score combining various aspects of component matches and similarity score. Geocoder 510 can ensure that additional extraneous information in the address does not affect the component matches and hence the final score reflects more accurately the actual confidence of the response and the geocode to return multiple responses. Geocoder 510 can differentiate between component types and component matches count. Geocoder 510 can utilize a sort methodology to arrive at a best response.

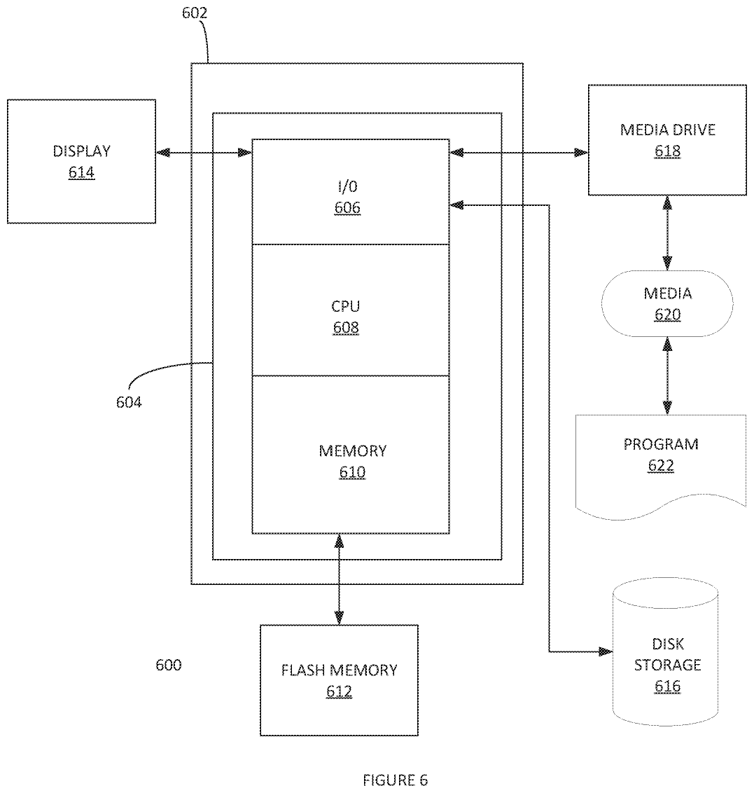

FIG. 6 depicts an exemplary computing system 600 that can be configured to perform any one of the processes provided herein. In this context, computing system 600 may include, for example, a processor, memory, storage, and I/O devices (e.g., monitor, keyboard, disk drive, Internet connection, etc.). However, computing system 600 may include circuitry or other specialized hardware for carrying out some or all aspects of the processes. In some operational settings, computing system 600 may be configured as a system that includes one or more units, each of which is configured to carry out some aspects of the processes either in software, hardware, or some combination thereof.

FIG. 6 depicts computing system 600 with a number of components that may be used to perform any of the processes described herein. The main system 602 includes a motherboard 604 having an I/O section 606, one or more central processing units (CPU) 608, and a memory section 610, which may have a flash memory card 612 related to it. The I/O section 606 can be connected to a display 614, a keyboard and/or other user input (not shown), a disk storage unit 616, and a media drive unit 618. The media drive unit 618 can read/write a computer-readable medium 620, which can contain programs 622 and/or data. Computing system 600 can include a web browser. Moreover, it is noted that computing system 600 can be configured to include additional systems in order to fulfill various functionalities. Computing system 600 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

Example Use Case Process

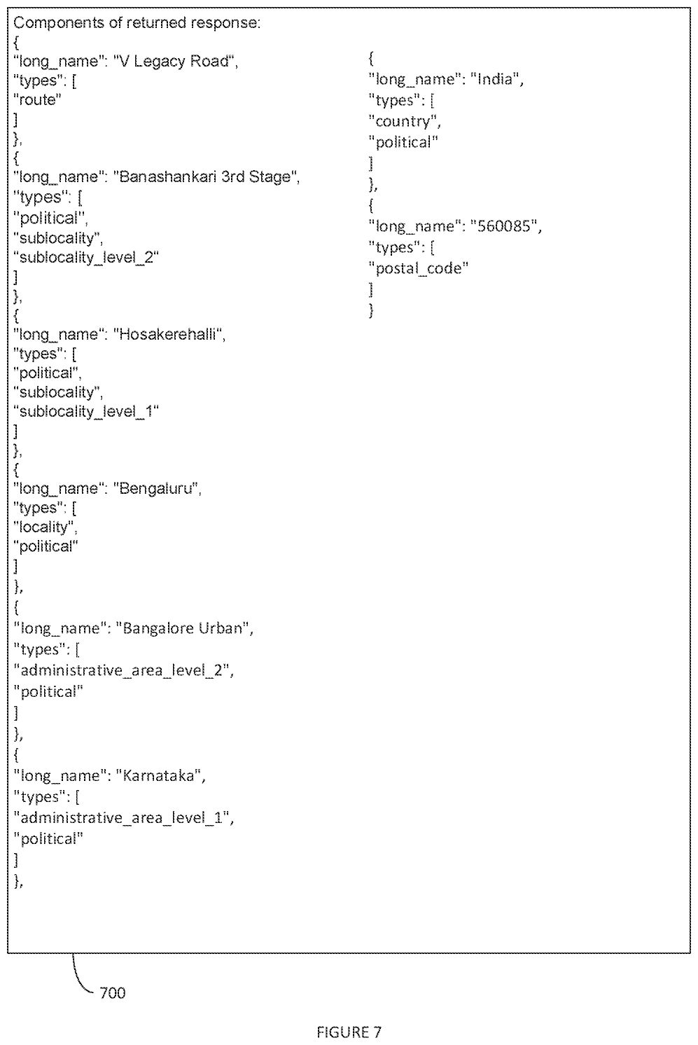

FIG. 7 illustrates an example use case 700, according to some embodiments. The example address to be geocoded:

‘Sobha Valley View, Dwarka Nagar, Hosakerehalli, Banashankari 3rd stage, VLegacy road, opposite to VLegacy convention center, -, 560098’.

1st query address: ‘sobha valley view dwarka nagar banashankari v legacy road opposite to convention center,hosakerehalli,stage 3,bengaluru,560098’.

Response 1: ‘V Legacy Rd, Banashankari 3rd Stage, Hosakerehalli, Bengaluru, Karnataka 560085, India’.

FIG. 7 illustrates the example components of returned response.

After applying processes 100-300 and traversing through the component values and the original address, the example output can be:

Component types matched: 2 (street, locality)

Components matched: 3 (V legacy road for street, Banashankari 3rd Stage for locality and Hosakerehalli for locality)

Similarity score: 60

Precision score: 230

Confidence score=60+25*2+5*3=125

Final confidence score after normalizing and rounding down=125/225*100=55

The output looks likes this:

“integratedConfidence”: {
“components”: {
“matchingComponentTypesCount”: 2,
“similarityScore”: 60,
“matchingComponentsCount”: 3
},
“integratedConfidenceScore”: 55

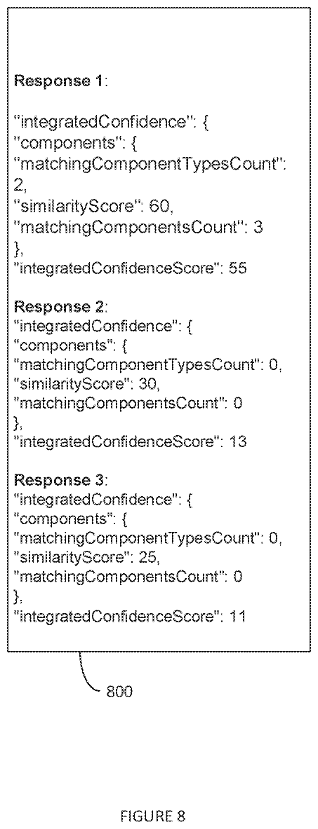

FIG. 8 illustrates an example set 800 of other returned confidence scores that are not selected, according to some embodiments. Example set 800 can include returned responses 2-4 that are not selected.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computerized method for confidence scoring of geocoder results in computer-based navigation comprising:
identifying a set of main components of an address that have a highest importance for a specified geography are identified;
providing a geocoding database comprising a dataset of geocoded addresses of a geocoder;
receiving a set of responses from the geocoding database, wherein each response comprises a geocoded addresses of the geocoding database;
breaking each response into a set of components;
based on the set of components, matching the address and each response in the set of components;
based on the match, calculating a string similarity score and a component match score of each response between the address and each response;
sorting the responses based on the string similarity score of each response and the component match score of each response;
selecting a first response of the set of responses after sorting as the best response; and
calculating a confidence score of the first response, wherein the confidence score is calculated using a formula which depends on the string similarity score and the component match score of the first response.

2. The computerized method of claim 1, wherein the locality comprises a city.

3. The computerized method of claim 2, wherein the set of main components of an address comprises a point of interest component, a country component, a state component, a city component, a street component, a postal code component or a locality component.

4. The computerized method of claim 3, wherein the point of interest component comprises a premise identity, an establishment identity, or a building identity.

5. The computerized method of claim 3, wherein the street component comprises a route identity or an intersection identity.

6. The computerized method of claim 3, wherein the locality component comprises a neighborhood identity, a sub-locality identity, or an administrative levels identity.

7. The computerized method of claim 6, wherein the confidence score is calculated as:
confidence score=similarity score+25*component types matched+5*components matched.

8. The computerized method of claim 7, wherein the confidence score is normalized by dividing the confidence score by a specified value and then multiplied by 100 and rounded down to convert it into an integer.

9. A computerized geocoding method comprising:
providing an original address to be geocoded by a geocoder;
receiving from a geocoder database a plurality of responses;
breaking each response of the plurality of responses into multiple components;
for each response, implementing:
checking that a value of each of the components matches with parts of the original address;
counting a number of component values that matched with parts of the original address;
counting the number of component types that have been matched;
determining a string similarity score between each returned response and the original address; and
determining a precision score of the returned response.

10. The computerized geocoding method of claim 7 further comprising:
selecting a best response with a highest string similarity score and a highest precision score.

11. The computerized geocoding method of claim 10 further comprising:
calculating a confidence score for the best response.

12. A computerized system for confidence scoring of geocoder results in computer-based navigation comprising:
a processor;
a memory containing instructions when executed on the processor, causes the processor to perform operations that:
identify a set of main components of an address that have a highest importance for a specified geography are identified;
provide a geocoding database comprising a dataset of geocoded addresses of a geocoder;
receive a set of responses from the geocoding database, wherein each response comprises a geocoded addresses of the geocoding database;
breaking each response into a set of components;
based on the set of components, match the address and each response in the set of components;
based on the match, calculate a string similarity score and a component match score of each response between the address and each response;
sort the responses based on the string similarity score of each response and the component match score of each response;
select a first response of the set of responses after sorting as the best response; and
calculate a confidence score of the first response, wherein the confidence score is calculated using a formula which depends on the string similarity score and the component match score of the first response.

13. The computerized system of claim 12, wherein the locality comprises a city.

14. The computerized system of claim 12, wherein the set of main components of an address comprises a point of interest component, a country component, a state component, a city component, a street component, a postal code component or a locality component.

15. The computerized system of claim 13, wherein the point of interest component comprises a premise identity, an establishment identity, or a building identity.

16. The computerized system of claim 13, wherein the street component comprises a route identity or an intersection identity.

17. The computerized system of claim 13, wherein the locality component comprises a neighborhood identity, a sub-locality identity, or an administrative levels identity.

18. The computerized system of claim 17, wherein the confidence score is calculated as:
confidence score=similarity score+25*component types matched+5*components matched.

19. The computerized system of claim 20, wherein the confidence score is normalized by dividing the confidence score by a specified value and then multiplied by 100 and rounded down to convert it into an integer.
